(19) United States
(12) Patent Application Publication
(10) Pub. No.: US 2018/0079012 A1
(43) Pub. Date: Mar. 22, 2018

(54) Holding Device

(71) Applicant: Canon Virginia, Inc., Newport News, VA (US)

(72) Inventor: Dwayne Watson, Gasburg, VA (US)

(21) Appl. No.: 15/273,491

(22) Filed: Sep. 22, 2016

(51) Int. Cl. B23B 31/20; B23Q 3/06

(52) U.S. Cl. CPC B23B 31/20; B23B 2231/2008; B23Q 3/067

(57) ABSTRACT

Some embodiments of a device comprise a collet, a holder that has a proximal end that is configured to hold the collet and a distal end that has a cavity, and a holder sleeve at the proximal end of the holder. Also, the holder sleeve is configured to increase a grip of the collet, the collet and the holder define an opening that is configured to receive a pin, the opening extends from the cavity through a center of the holder and a center of the collet along a longitudinal axis of the collet and a longitudinal axis of the holder, and the cavity of the holder is wider than the opening.

### BACKGROUND

### Technical Field

This application generally relates to milling.

### Background

Milling removes material from a workpiece with rotary cutters. Some milling devices are computer numerical control (CNC) devices, which can use instructions that were generated by computer-aided design (CAD) programs and computer-aided manufacturing (CAM) programs.

### SUMMARY

Some embodiments of a device comprise a collet, a holder that has a proximal end that is configured to hold the collet and a distal end that has a cavity, and a holder sleeve at the proximal end of the holder. Also, the holder sleeve is configured to increase a grip of the collet, the collet and the holder define an opening that is configured to receive a pin, the opening extends from the cavity through a center of the holder and a center of the collet along a longitudinal axis of the collet and a longitudinal axis of the holder, and the cavity of the holder is wider than the opening.

Some embodiments of a device comprise a holder that has a proximal end that is configured to hold a collet and a distal end that has a cavity, wherein the proximal end of the holder is configured to be gripped by a holder sleeve that is configured to increase a grip of the collet, wherein the holder defines a cylindrical opening that extends, along a longitudinal axis of the holder, through the holder from the cavity to the proximal end, and wherein the cavity of the holder is wider than a narrowest part of the cylindrical opening.

Some embodiments of a method comprise inserting a pin, which includes a head and a shaft that is narrower than the head, into a holding device. The holding device includes a collet that grips the pin, a holder that has a proximal end that is configured to hold the collet and a distal end that has a cavity, and a holder sleeve at the proximal end of the holder, wherein the holder sleeve is configured to increase the grip of the collet, wherein the collet and the holder define an opening, wherein the opening extends from the cavity through a center of the holder and a center of the collet along a longitudinal axis of the collet and a longitudinal axis of the holder, and wherein the cavity of the holder is wider than the opening. Also, the pin is inserted into the holder such that the head of the pin is positioned in the cavity and the shaft of the pin is positioned in the opening and extends through the opening and out of the collet and the proximal end of the holder, such that an end of the pin opposite to the head is exposed.

### BRIEF DESCRIPTION OF THE DRAWINGS

FIG. 1 illustrates an example embodiment of a holding device.

FIG. 2 illustrates a partial cutaway view of an example embodiment of a holding device.

FIG. 3 illustrates an exploded view of an example embodiment of a holding device.

FIG. 4 illustrates a perspective view of a chuck plate and an exploded perspective view of a holding device.

FIG. 5 illustrates a perspective view of holding devices that are mounted on a chuck plate.

FIG. 6 illustrates an exploded perspective view of an example embodiment of a holding device.

FIG. 7 illustrates a cutaway view of an example embodiment of a holding device.

FIG. 8 illustrates a cutaway view of an example embodiment of a holding device.

FIG. 9A illustrates an exploded view of an example embodiment of a holding device.

FIG. 9B illustrates a cutaway cross-sectional view of the example embodiment of a holder from the line II-II in FIG. 9A.

FIG. 9C illustrates a cutaway cross-sectional view of the example embodiment of a holder from the line II-II in FIG. 9A.

FIG. 10 illustrates a cutaway view of an example embodiment of a holder.

FIG. 11 illustrates a partial cutaway view of an example embodiment of a holder.

FIG. 12 illustrates a perspective view of an example embodiment of a holder.

### DESCRIPTION

The following paragraphs describe certain explanatory embodiments. Other embodiments may include alternatives, equivalents, and modifications. Additionally, the explanatory embodiments may include several novel features, and a particular feature may not be essential to some embodiments of the devices, systems, and methods that are described herein.

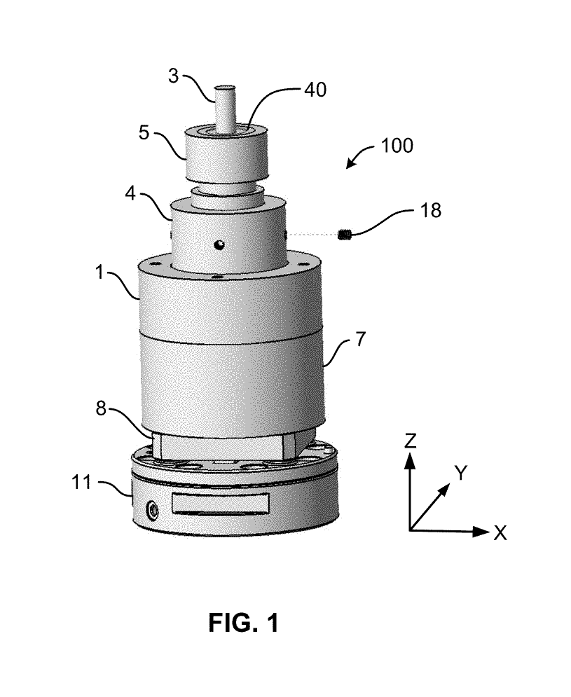

FIG. 1 illustrates an example embodiment of a holding device 100. The holding device 100 holds a pin 3. The holding device 100 includes a holder cap 1, a holder 4, a holder sleeve 5, and a holder receiver 7. The holding device 100 can be affixed to a macro pallet 8, which can be attached to a macro chuck 11.

The holder 4 can hold a chuck 40 (e.g., a collet chuck, a scroll chuck) that can grip an inserted pin 3. In this embodiment, the chuck 40 is a collet chuck (collet 40), and the grip of the collet 40 can be adjusted by moving the holder sleeve 5 to make the collet 40 squeeze the pin 3 more or to make the collet 40 squeeze the pin 3 less.

Additionally, by using a proper device (e.g., a zero setter, such as an SPZ-2 “R” Zero Setter), the runout of the pin 3 can be adjusted by loosening or tightening one or more adjustment members 18 (e.g., a screw) in the holder 4. Thus, the runout of the pin 3 can be adjusted before a holding device 100 that grips a pin 3 is inserted into a milling machine. Furthermore, in some embodiments, the collet 40 of the holder 4 grips the pin 3 on nearly the entire circumference of the pin 3 and along a length of the pin 3.

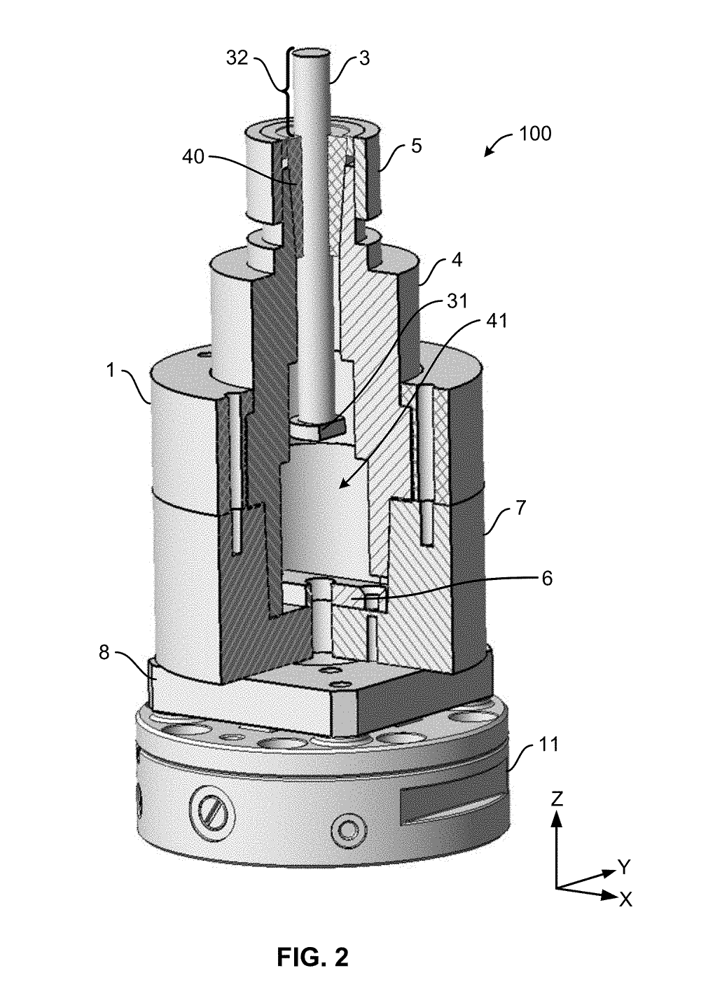

FIG. 2 illustrates a partial cutaway view of an example embodiment of a holding device 100. The holding device 100 includes a holder cap 1, a holder 4, a holder sleeve 5, a chuck 40 (which is a collet in this example), and a holder receiver 7. The holding device 100 has been partially cutaway along the X-Z plane and along the Y-Z plane. In addition, the holding device 100 includes a locating key 6.

The holder 4 holds the chuck 40 (collet 40). The holder sleeve 5 can be adjusted (e.g., turned) to tighten the grip of the collet 40 or to loosen the grip of the collet 40 on the pin 3. For example, the holder sleeve 5 can be turned to screw the holder sleeve 5 onto the holder 4, which moves the holder sleeve 5 toward the end of the holder 4 that is distal to the holder sleeve 5, which in turn forces the collet 40 further into the holder 4, which causes the collet 40 to more firmly grip the pin 3.

Also, the holder 4 has a cavity 41 that is large enough to surround a head 31 of the pin 3. The pin 3 can be inserted into the holder 4 through the cavity 41 until a portion 32 of the pin 3 extends outside the holder 4. The portion 32 of the pin 3 that is outside the holder 4 can be machined (e.g., milled). Accordingly, while the pin 3 is milled, the head 31 of the pin 3 is enclosed in the cavity 41 by the holder 4 and the holder receiver 7.

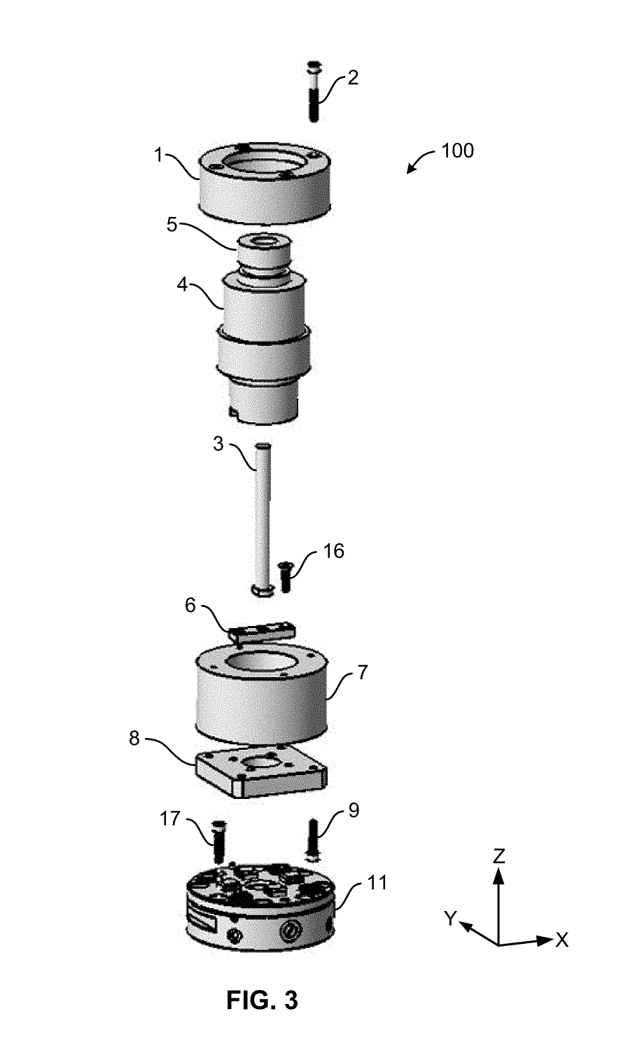

FIG. 3 illustrates an exploded view of an example embodiment of a holding device 100. The holding device 100 includes a holder cap 1, a holder 4, a holder sleeve 5, a locating key 6, and a holder receiver 7. A first screw 2 attaches the holder cap 1 to the holder receiver 7, a second screw 16 attaches the locating key 6 to the holder receiver 7, and a third screw 9 attaches a macro pallet 8 to the holder receiver 7. A fourth screw 17 attaches the macro pallet 8 to the macro chuck 11.

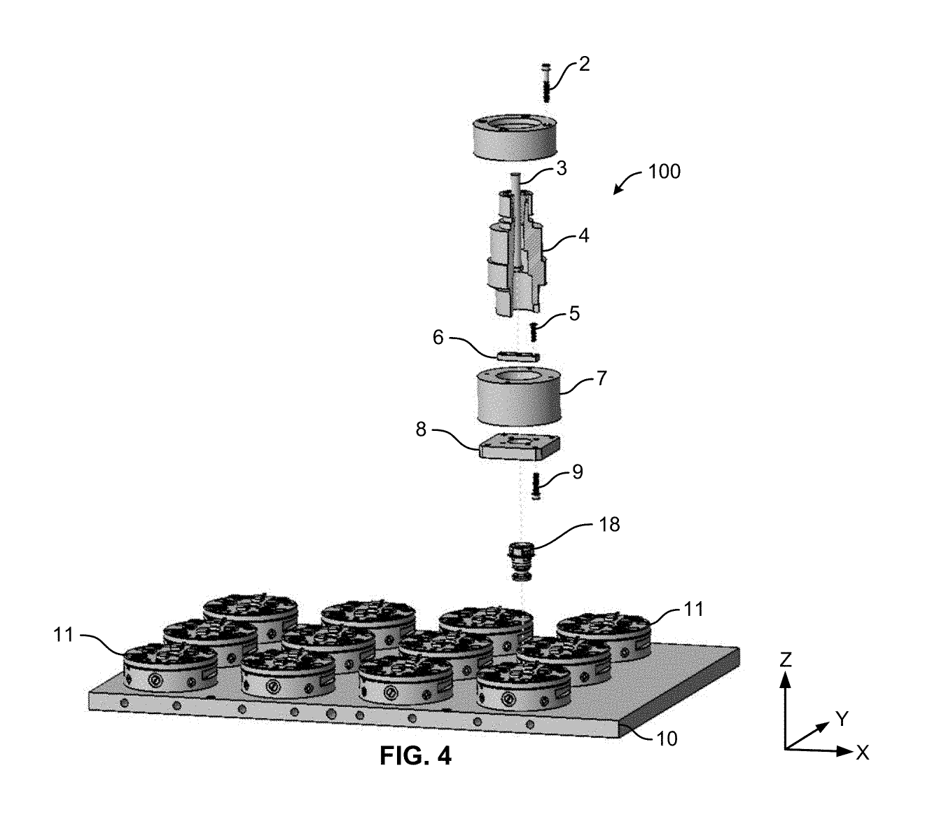

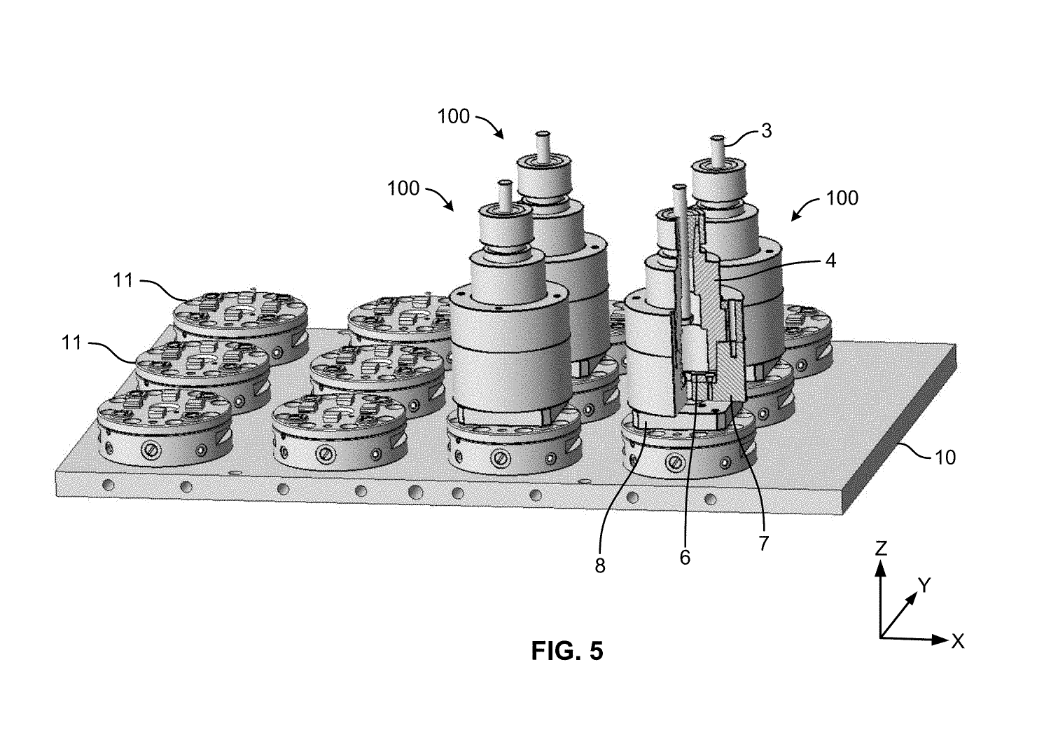

FIG. 4 illustrates a perspective view of a chuck plate 10 and an exploded perspective view of a holding device 100. The chuck plate 10 includes an array of macro chucks 11. This embodiment also includes a draw bar 18. The draw bar 18 attaches to the macro pallet 8, and the macro chuck 11 pull the draw bar 18 down, thereby securing the macro pallet 8 to the macro chuck 11. A respective holding device 100 can be attached to each of the macro chucks 11. For example, FIG. 5 illustrates a perspective view of holding devices 100 that are mounted on a chuck plate 10. One of the holding devices 100 is shown in a partial cutaway view.

The chuck plate 10 allows a user to insert multiple pins 3 into respective holding devices 100 and adjust the respective runouts of the pins 3 before the chuck plate 10 is loaded into a milling machine. Thus, the setup labor can be external to the milling machine. This can allow more efficient use of the milling machine, because the setup of the pins 3 can be performed while the milling machine is being used to mill other pins 3 that were already setup on another chuck plate 10.

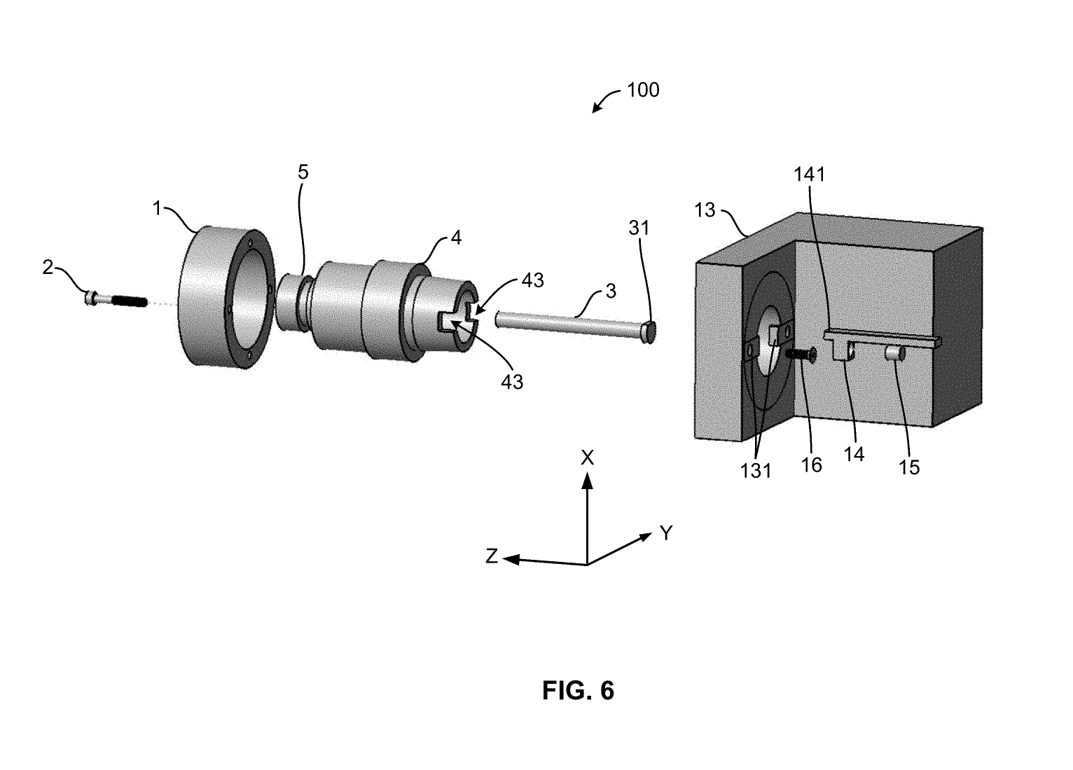

FIG. 6 illustrates an exploded perspective view of an example embodiment of a holding device 100. The holding device 100 includes a holder cap 1, a holder 4, a holder sleeve 5, and a holder block 13. The holding device 100 also includes a pin-measurement key 14, which has a ridge 141, and a magnet 15. The ridge 141 forms an L-shaped surface on an end of the pin-measurement key 14.

The holder 4 includes two locators 43 at an end of the holder 4 that is distal to the holding sleeve 5. Also, the holder block 13 includes two cantilevered extensions 131. In this example embodiment, the two extensions 131 are attached to the holder block 13 by respective screws 16 (one of which is shown in FIG. 6). The locators 43 are sized to grip the extensions 131 when the holder 4 is inserted into the holder block 13. Also, the ridge 141 of the pin-measurement key 14 is configured to abut a flat side of the head 31 of the pin 3, and the magnet 15 can attach the pin-measurement key 15 to the head 31 of the pin 3. Furthermore, the space between the extensions 131 is sized to grip the pin-measurement key 14 when the pin-measurement key 14 is inserted into the extensions 131.

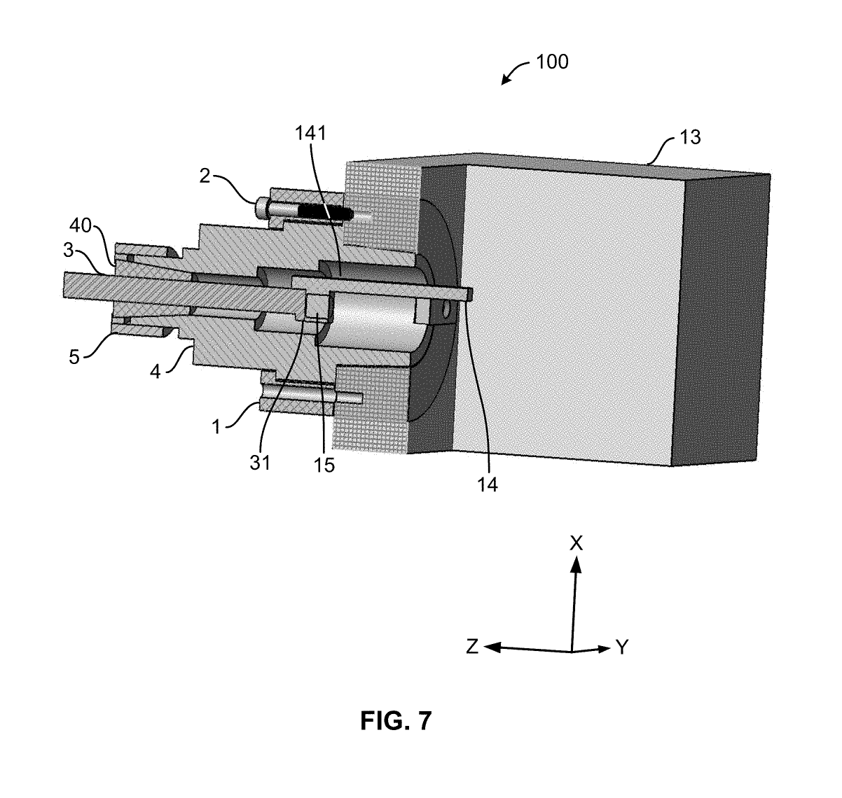

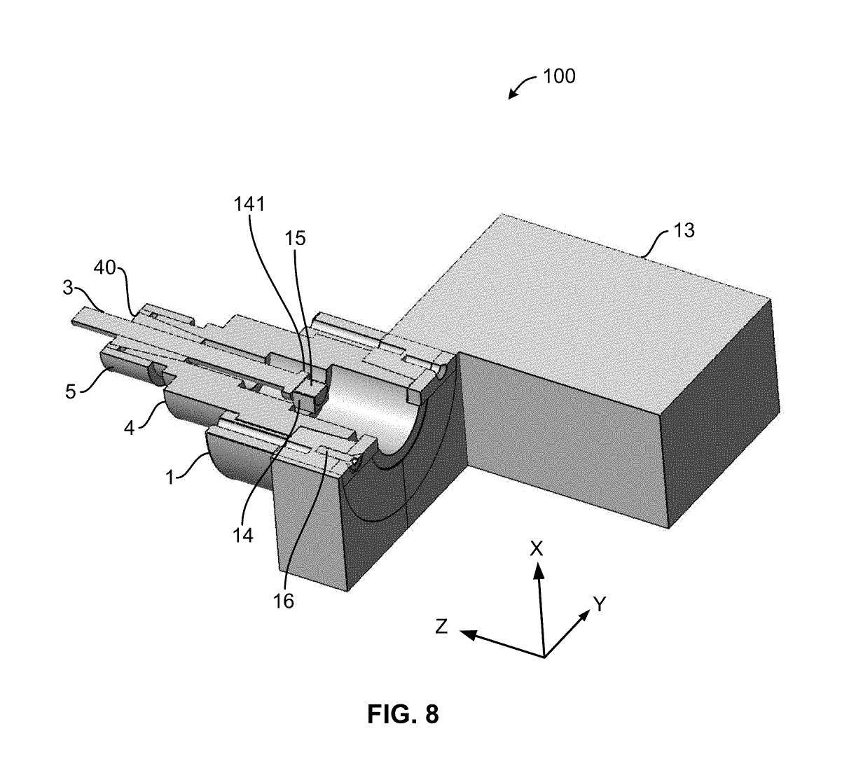

When the members that are shown in FIG. 6 are assembled (for example, see FIG. 7 or FIG. 8), the ridge 141 of the pin-measurement key 14 rests on the flat of the head 31 of the pin 3, and the holder 4 is inserted into the holder block 13, with the locators 43 gripping the extensions 131 while the pin-measurement key 14 is attached to the head 31 of the pin 3. Thus, when the member are assembled, the locators 43 and the extensions 131 prevent the holder 4 from rotating relative to the holder block 13, and the pin-measurement key 15 and the extensions 131 prevent the pin 3 from rotating relative to the holder 4. Thus, the holder 4 holds the pin 3 in the same rotational orientation.

Also, the entire assembly can be placed on a surface plate, where an indicator can be used to check the parallelism of the flat on the head 31 of the pin 3. Because the flat of the head 31 of the pin 3 may not be reachable with the indicator, the pin-measurement key 14 and the magnet 15 are used as an extension of the indicator. The pin 3 can be rotated until the indicator reads zero, and, after reaching the desired measurement, the grip of the holder 4 on the pin 3 can be increased and the pin-measurement key 14 and the magnet 15 can be removed. The holder 4, which still grips the pin 3, can then be removed and installed on a chuck plate for processing. Also, when the holder 4 is installed on the chuck plate, the holder 4 may be installed such that the flat of the head 31 of the pin 3 in oriented in a specific, known direction.

FIG. 7 illustrates a cutaway view of an example embodiment of a holding device 100. This view is cutaway along the X-Z plane. In this view, the pin-measurement key 14 abuts the pin 3. The ridge 141 of the pin-measurement key 14 abuts a flat side of the head 31 of the pin 3, thereby orienting the pin 3. Also, FIG. 8 illustrates a cutaway view of the example embodiment of a holding device. This view is cutaway along the Y-Z plane.

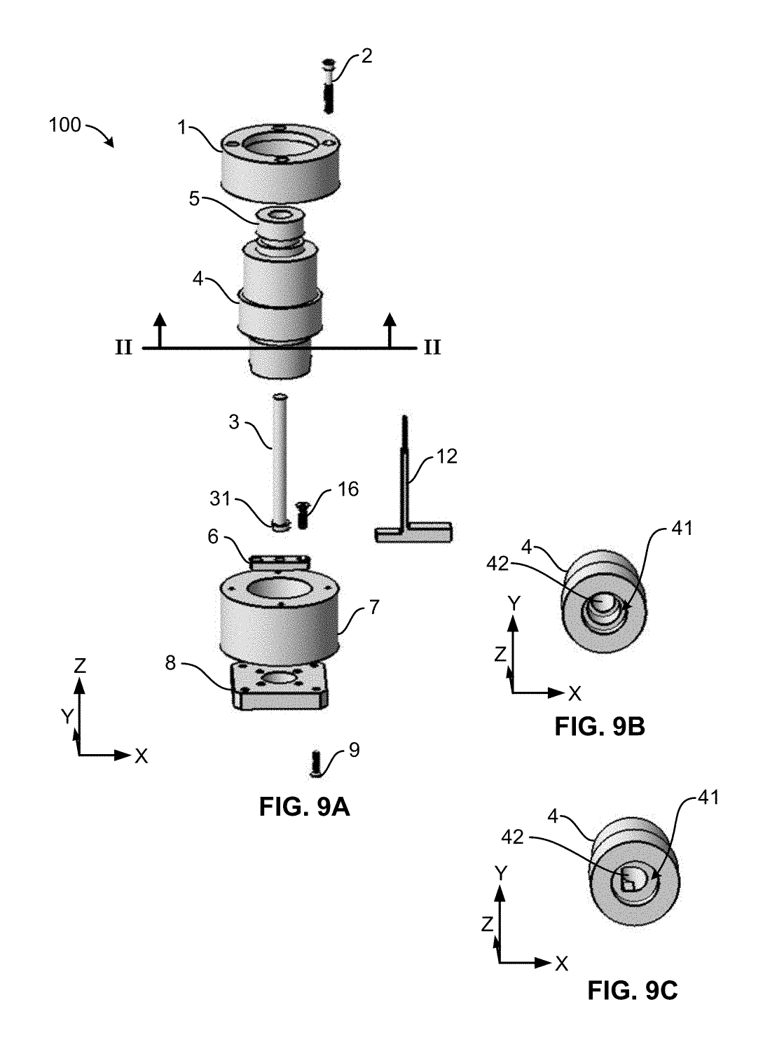

FIG. 9A illustrates an exploded view of an example embodiment of a holding device 100. The holding device 100 includes a holder cap 1, a holder 4, a holder sleeve 5, a locating key 6, and a holder receiver 7. Four screws 2 attach the holder cap 1 to the holder receiver 7. Also, two screws 16 attach the locating key 6 to the holder receiver 7, and two or more screws 9 attach a macro pallet 8 to the holder receiver 7. The holder 4 has an end that is distal to the holder sleeve 5, and this end includes locators (for example, see the locators 43 in FIG. 6) that are configured to fit the locating key 6. Thus, when the holder 4 is gripped by the holder cap 1 and the holder receiver 7, the locating key 6 and the locators prevent the holder 4 from rotating relative to the holder receiver 7 and the holder cap 1.

A pin 3 is inserted into the holder 4 through the end that is distal to the holder sleeve 5. Some embodiments of the pin 3 include a flat side on the head 31. The flat side of the head 31 can be oriented with a pin-alignment member (e.g., a pin-alignment key 12, a pin-measurement key).

The end of the holder 4 that is distal to the holder sleeve 5 is inserted into the holder receiver 7. Thus, the holder 4 is partially inserted into the holder receiver 7. Starting with the end of the holder 4 that is proximate to the holder sleeve 5, the holder is inserted into the holder cap 1 until the holder cap 1 meets the holder receiver 7. The holder cap 1 is attached to the holder receiver 7 with the first screw 2. The holder receiver 7 is attached to the macro pallet 8 with the third screw 9.

FIG. 9B illustrates a cutaway cross-sectional view of an example embodiment of the holder 4 from the line II-II in FIG. 9A. The holder 4 includes a cavity 41. The holder 4 also includes a space 42 that extends through the center of the holder 4 along the longitudinal axis of the holder 4, which is the Z axis in FIG. 9B.

FIG. 9C illustrates a cutaway cross-sectional view of an example embodiment of the holder 4 from the line II-II in FIG. 9A. The holder 4 includes a cavity 41. The holder 4 also includes a space 42 that extends through the center of the holder 4 along the longitudinal axis of the holder 4, which is the Z axis in FIG. 9B. In this embodiment, the space 42 includes a portion that has a D-shaped cross section.

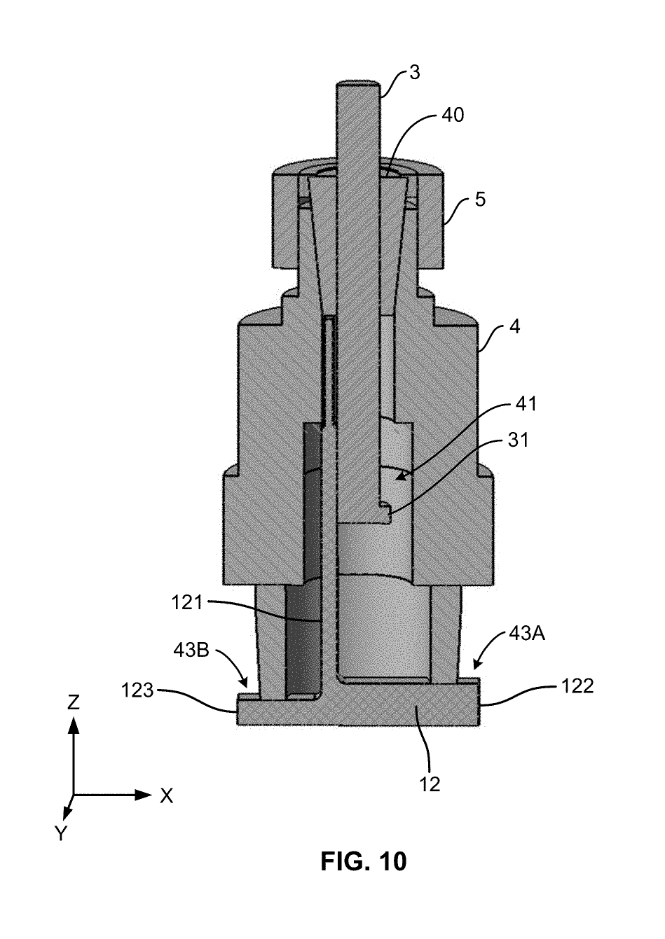

FIG. 10 illustrates a cutaway view of an example embodiment of a holder 4. This embodiment of the holder 4 includes a locator 43A at an end of the holder 4 that is distal to the holder sleeve 5. The locator 43A receives and holds a first extension 122 of the pin-alignment key 12. The pin-alignment key 12 also has a member 121 that extends through the cavity 41 of the holder 4 to the head 31 of the pin 3. Thus, the pin-alignment key 12 has an approximate T-shape. The member 121 has a flat surface that abuts a flat side of the head 31 of the pin 3, thereby fixing the orientation of the pin 3.

This embodiment of the holder 4 also has a second locator 43B that is not as deep as the first locator 43A. The second locator 43B is configured to hold a second extension 123 of the pin-alignment key 12. Thus, these embodiments of the holder 4 hold both the first extension 122 and the second extension 123 of the pin-alignment key in respective locators (i.e., the first locator 43A and the second locator 43B). Also, embodiments of the holder 4 that work with a locating key (e.g., the locating key 6 in FIG. 2) may have locators (i.e., the first locator 43A and the second locator 43B) that are deep enough to hold both the locating key and a respective one of the first extension 122 and the second extension 123.

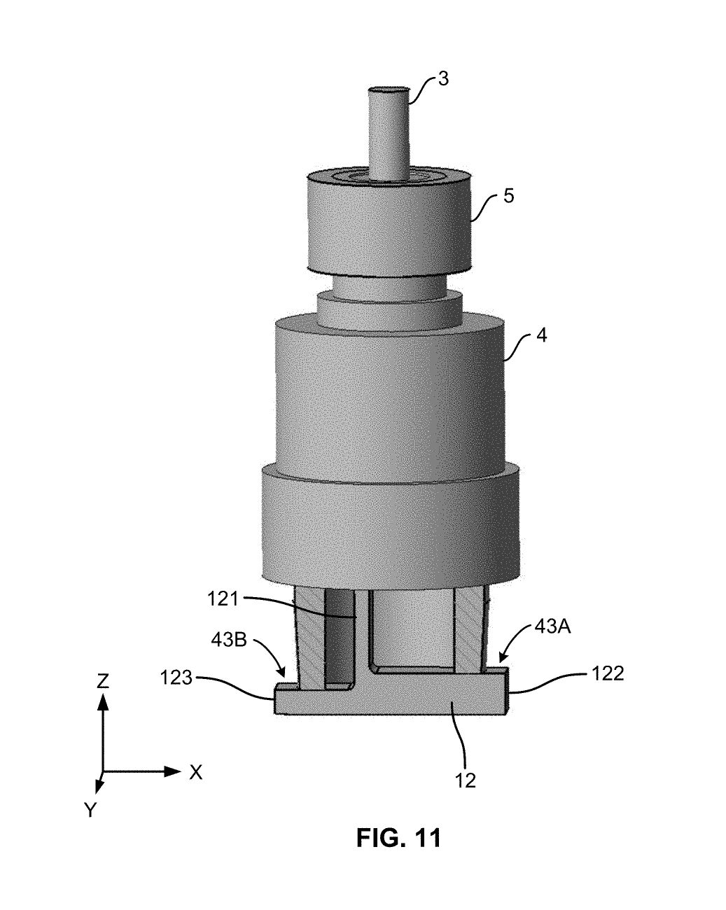

FIG. 11 illustrates a partial cutaway view of the example embodiment of a holder 4. This embodiment of the holder 4 includes a first locator 43A and a second locator 43B.

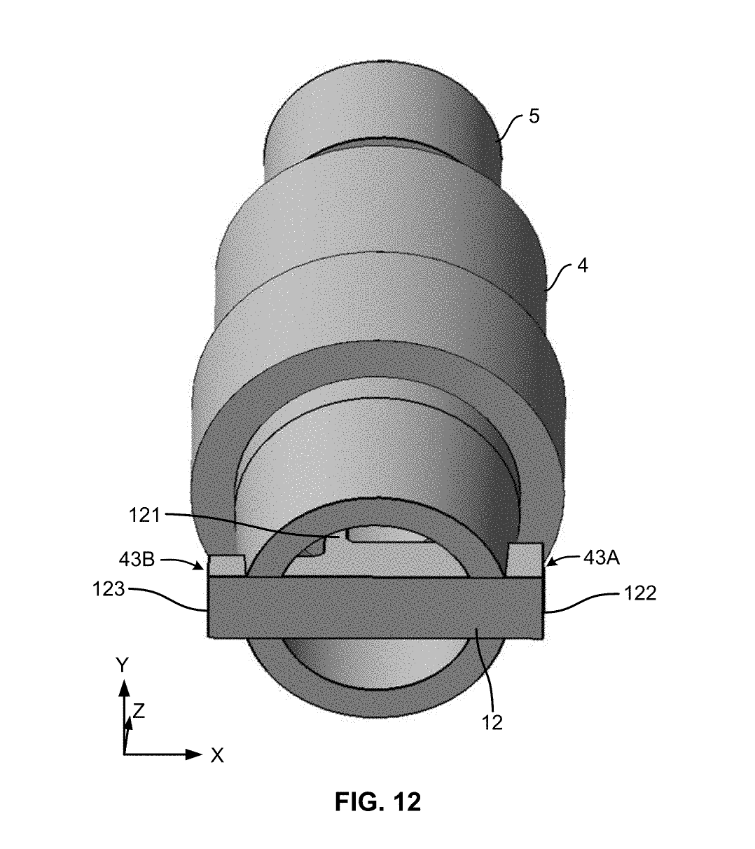

FIG. 12 illustrates a perspective view of an example embodiment of a holder 4. This embodiment of the holder 4 includes a first locator 43A and a second locator 43B. The first locator 43A holds a first extension 122 of the pin-alignment key 12, and the second locator 43B holds a second extension 123 of the pin-alignment key 12.

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A device comprising:
a collet;
a holder that has a proximal end that is configured to hold the collet and a distal end that has a cavity; and
a holder sleeve at the proximal end of the holder,
wherein the holder sleeve is configured to increase a grip of the collet,
wherein the collet and the holder define an opening,
wherein the opening extends from the cavity through a center of the holder and a center of the collet along a longitudinal axis of the collet and a longitudinal axis of the holder, and
wherein the cavity of the holder is wider than the opening.

2. The device of claim 1, further comprising:
a pin-alignment member that is configured to contact a flat side of a head of a pin.

3. The device of claim 2, wherein the pin-alignment member has an extension that is configured to be received by a locator in distal end of the holder.

4. The device of claim 2, wherein the pin-alignment member has an L-shaped end that is configured to abut the pin, and the L-shaped end includes a ridge that is configured to contact the flat side of the head of the pin.

5. The device of claim 4, wherein the pin-alignment member includes a magnet at the L-shaped end.

6. The device of claim 2, further comprising:
a holder cap that has an opening that is configured to surround a first part of the holder, wherein the holder cap includes a first surface; and
a holder receiver that has an opening that is configured to surround a second part of the holder, wherein the holder receiver includes a second surface that is configured to mate with the first surface of the holder cap, and wherein the holder cap and the holder receiver are configured to secure the holder when the first surface is mated to the second surface while the holder cap and the holder receiver surround the holder.

7. The device of claim 6, wherein the holder cap further comprises one or more adjustment members that are configured to adjust a runout of the pin while the pin is received by the opening.

8. A device comprising:
a holder that has a proximal end that is configured to hold a collet and a distal end that has a cavity,
wherein the proximal end of the holder is configured to be gripped by a holder sleeve that is configured to increase a grip of the collet,
wherein the holder defines a cylindrical opening that extends, along a longitudinal axis of the holder, through the holder from the cavity to the proximal end, and
wherein the cavity of the holder is wider than a narrowest part of the cylindrical opening.

9. The device of claim 8, wherein the holder further comprises a locator at the distal end.

10. The device of claim 8, wherein the holder is configured to hold the collet such that the collet extends into the cylindrical opening but does not extend to the cavity.

11. A method comprising:
inserting a pin, which includes a head and a shaft that is narrower than the head, into a holding device, wherein the holding device includes
a collet that grips the pin,
a holder that has a proximal end that is configured to hold the collet and a distal end that has a cavity, and
a holder sleeve at the proximal end of the holder,
wherein the holder sleeve is configured to increase the grip of the collet,
wherein the collet and the holder define an opening,
wherein the opening extends from the cavity through a center of the holder and a center of the collet along a longitudinal axis of the collet and a longitudinal axis of the holder, and
wherein the cavity of the holder is wider than the opening, and
wherein the pin is inserted into the holder such that the head of the pin is positioned in the cavity and the shaft of the pin is positioned in the opening and extends through the opening and out of the collet and the proximal end of the holder, such that an end of the pin opposite to the head is exposed.

12. The method of claim 11, further comprising
abutting an L-shaped end of a pin-alignment member to the head of the pin;
rotating the pin and the pin-alignment member; and
increasing the grip of the collet after rotating the pin and the pin-alignment member.

13. The method of claim 12, further comprising:
removing the pin-alignment member after increasing the grip of the collet.

14. The method of claim 13, further comprising:
inserting the holder into a holder receiver.

15. The method of claim 14, further comprising:
milling the end of the pin opposite to the head.

16. The method of claim 14, further comprising:
attaching the holder receiver to a chuck plate.
